(19) United States
(12) Patent Application Publication
(10) Pub. No.: US 2011/0128747 A1
(43) Pub. Date: Jun. 2, 2011

(54) Lamp Holder with an Improved Electric Wire Securing Structure

(76) Inventor: Ming Jen Hsiao, Toufen (TW)

(21) Appl. No.: 12/626,979

(22) Filed: Nov. 30, 2009

(51) Int. Cl. F21S 8/00

(52) U.S. Cl. 362/432

(57) ABSTRACT

A lamp holder includes an electrically insulative holder base for holding a lamp bulb, a plastic bracket fastened to the rear side of the holder base, the plastic bracket having a transverse extension lug, a wire hole cut through the transverse extension lug and two wire notches at two sides relative to the transverse extension lug, and two insulated electric wires inserted through the wire hole on the transverse extension lug and turned backwardly apart and respectively attached to the wire notches for electrically connecting two metal terminals in the holder base to an external power source.

### BACKGROUND OF THE INVENTION

1. Field of the Invention

The present invention relates to lamp installation technology and more particularly, to a lamp holder for holding a lamp bulb, which positively secures the insulated electric wires in place, preventing disconnection between the insulated electric wires and the metal terminals when the insulated electric wires are stretched accidentally.

2. Description of the Related Art

A regular lamp holder generally comprises an electrically insulative holder base prepared from ceramic and an electrically insulative bracket molded from plastics. The holder base has an internally threaded front receptacle for the connection of the base of a lamp bulb and two metal electrodes for the contact of the ring contact and tip contact of the lamp bulb. Further, the electrically insulative bracket is fastened to the rear side of the holder base. During installation, two electric wires respectively supported on the bracket and inserted into the inside of the holder base for electrically connecting the two electrodes to an external power source. In order to prevent disconnection between the two electric wires and the two electrodes upon an accidental external stretching force, electric wire holding down means is used to secure the electric wires to the bracket.

The most commonly used electric wire holding down device is comprised of a metal holding down plate and a plurality of tie screws. The metal holding down plate holds down the two electric wires on the bracket. The tie screws are adapted to affix to metal holding down plate to the bracket with screws. The use of the metal holding down plate and screws complicates the inventory control and delivery and increases the cost. Further, fastening and unfastening the tie screws and the metal holding down plate requires a particular tool. Thus, the use of the metal holding down plate and the tie screws greatly increases the installation time and labor.

### SUMMARY OF THE INVENTION

The present invention has been accomplished under the circumstances in view. It is one object of the present invention to provide a lamp holder for holding a lamp bulb, which prevents disconnection of the electric wires from the metal terminals when the electric wires are stretched accidentally, assuring a high level of safety. It is another object of the present invention to provide a lamp holder, which simplifies the electric wire mounting structure of the lamp holder, facilitating lamp holder fabrication, installation and delivery, and saving much the cost.

To achieve these and other objects of the present invention, a lamp holder comprises a lamp holder comprises a holder base adapted for holding a lamp bulb, an electrically insulative bracket fastened to one side of the holder base and two electric wires extended from the holder base and supported on the electrically insulative bracket for connection to an external power source, wherein the bracket comprises at least one extension lug, at least one wire notch located on the periphery of the at least one extension lug for the passing of the two electric wires, at least one wire hole cut through top and bottom sides of the at least one extension lug for the passing of the two electric wires, and two bearing portions defined between the at least one wire notch and the at least one wire hole for supporting the two electric wires respectively.

Further, each wire notch has a relatively narrower front open side and a relatively larger inner close side.

Further, each extension lug extends transversely from the periphery of the electrically insulative bracket.

In one embodiment of the present invention, the number of the at least one wire hole is 1 and the number of the at least one wire notch is 2 wherein the two wire notches are respectively disposed at two opposite lateral sides relative to the wire hole. Further, the wire hole is an oblong through hole.

In another embodiment of the present invention, the number of the at least one wire notch is 1 and the number of the at least one wire hole is 2, wherein the two wire holes are respectively disposed at two opposite lateral sides relative to the wire notch. Further, the wire notch is an oblong opening.

In still another embodiment of the present invention, the number of the at least one wire hole is 2 and the number of the at least one wire notch is 2, wherein the two wire notches are spaced between the two wire holes. Further, the two wire holes and the two wire notches are adapted for the passing of one single electric wire.

In still another embodiment of the present invention, the number of the at least one wire notch is 2 and the number of the at least one wire hole is 2, wherein the two wire holes are respectively disposed between the two wire notches. Further, the two wire holes and the two wire notches are adapted for the passing of one single electric wire.

### BRIEF DESCRIPTION OF THE DRAWINGS

FIG. 1 is an oblique top elevational view of a lamp holder in accordance with a first embodiment of the present invention.

FIG. 2 corresponds to FIG. 1, showing the electric wires removed.

FIG. 3 is an oblique top elevational view of a lamp holder in accordance with a second embodiment of the present invention.

FIG. 4 corresponds to FIG. 3, showing the electric wires removed.

FIG. 5 is an oblique top elevational view of a lamp holder in accordance with a third embodiment of the present invention.

FIG. 6 corresponds to FIG. 5, showing the electric wires removed.

FIG. 7 is an oblique top elevational view of a lamp holder in accordance with a fourth embodiment of the present invention.

FIG. 8 corresponds to FIG. 7, showing the electric wires removed.

### DETAILED DESCRIPTION OF THE PREFERRED EMBODIMENT

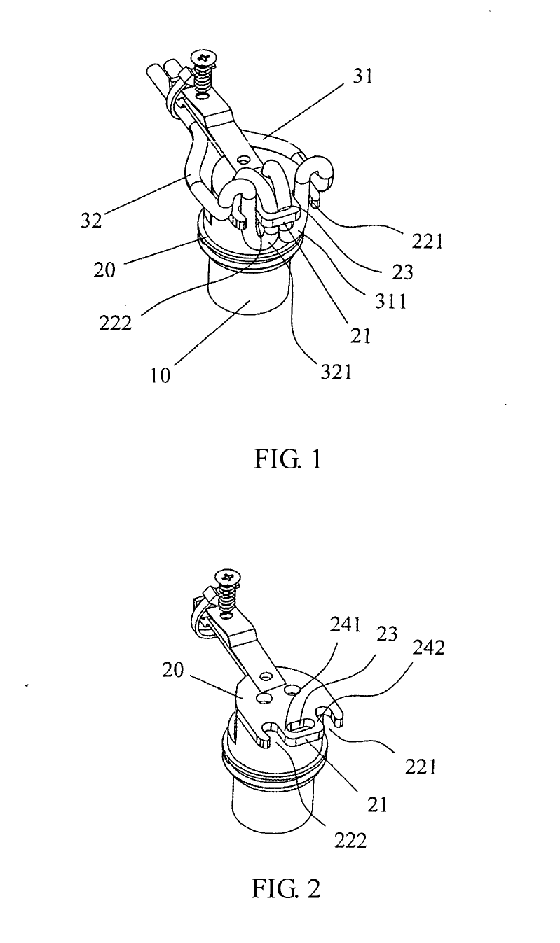

Referring to FIGS. 1 and 2, a lamp holder in accordance with a first embodiment of the present invention is shown comprising a holder base 10 prepared from ceramics and an electrically insulative bracket 20 molded from plastics.

The holder base 10 is adapted for holding a lamp on the front side thereof. The bracket 20 is fastened to the rear side of the holder base 10 opposite to its lamp-holding front side, having a transverse extension lug 21, two wire notches 221 and 222 cut through the free end of the transverse extension lug 21 and disposed at two opposite sides relative to the transverse extension lug 21 and a wire hole 23 vertically cut through the transverse extension lug 21. The transverse extension lug 21 has two parallel bearing portions 241 and 242 respectively defined between the wire notches 221 and 222 and the wire hole 23. According to this first embodiment, the wire hole 23 is an oblong hole for the passing of two electric wires 31 and 32. The wire notches 221 and 222 are single-sided openings, each having a relatively narrower front open side and a relatively larger rear close side adapted for securing the electric wires 31 and 32 positively in place.

The two electric wires 31 and 32 are inserted through the wire hole 23 in direction from the rear side toward the front side and then turned outwardly apart from each other and then backwardly through the wire notches 221 and 222 respectively, each having one end respectively inserted into the inside of the holder base 10 and electrically connected to one respective metal terminal (not shown) in the holder base 10 and the other end electrically connected to one pole (the positive pole or negative pole) of power source. Thus, each insulated electric wire 31 or 32 has a U-turn portion 311 or 321 hung on the associating bearing portion 241 or 242 of the transverse extension lug 21. When the two electric wires 31 and 32 are stretched accidentally by an external force, the two parallel bearing portions 241 and 242 of the transverse extension lug 21 resist against the stretching force, stopping transfer of the stretching force to the connection areas between the two electric wires 31 and 32 and the two metal terminal (not shown) in the holder base 10. Therefore, the two electric wires 31 and 32 will not be disconnected from the metal terminals in the holder base 10, assuring a high level of safety.

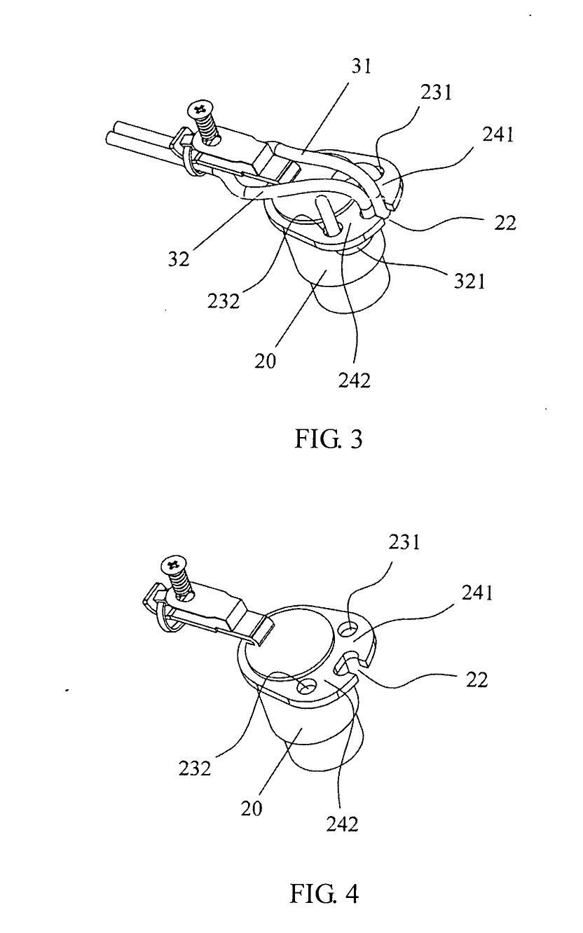

FIGS. 3 and 4 show a lamp holder in accordance with a second embodiment of the present invention. This second embodiment is substantially similar to the aforesaid first embodiment with the exception of the structure of the electrically insulative bracket 20. According to this second embodiment, the electrically insulative bracket 20 has a wire notch 22, two wire holes 231 and 232 disposed at two opposite sides relative to the wire notch 22, and two bearing portions 241 and 242 respectively defined between the wire notch 22 and the wire holes 231 and 232. The wire notch 22 is an oblong notch for the passing of two electric wires 31 and 32. The wire holes 231 and 232 are adapted for the passing of the two electric wires 31 and 32 individually.

During installation, the two electric wires 31 and 32 are respectively downwardly inserted through the wire holes 231 and 232 and then moved toward each other and turned upwardly through the wire notch 22.

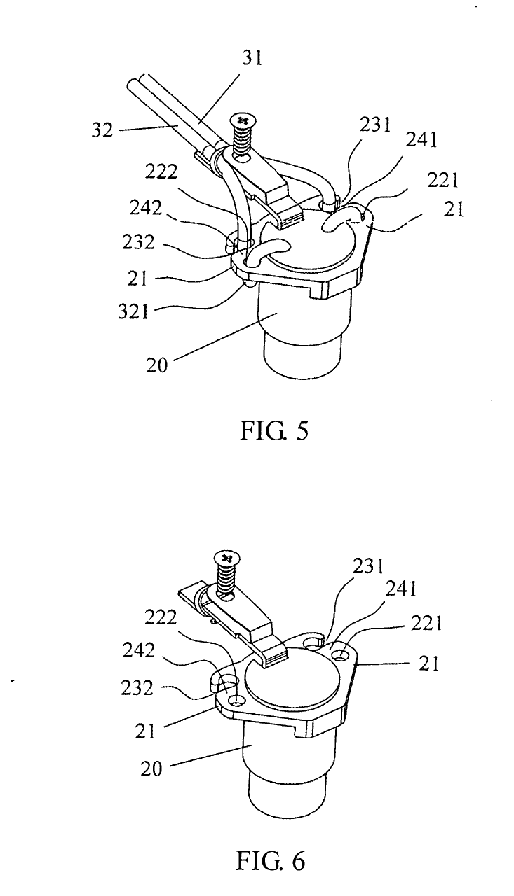

FIGS. 5 and 6 show a lamp holder in accordance with a third embodiment of the present invention. This third embodiment is substantially similar to the aforesaid first embodiment with the exception of the structure of the electrically insulative bracket 20. According to this third embodiment, the electrically insulative bracket 20 has two extension lugs 21 symmetrically disposed at two opposite lateral sides, two wire holes 221 and 222 respectively located on the extension lugs 21, two wire notches 231 and 232 respectively located on the extension lugs 21 adjacent to the wire holes 221 and 222, and two bearing portions 241 and 242 respectively defined in the extension lugs 21 between the wire holes 221 and 222 and the wire notches 231 and 232. The wire holes 221 and 222 and the wire notches 231 and 232 are adapted for the passing of the two electric wires 31 and 32 individually.

During installation, the two electric wires 31 and 32 are respectively downwardly inserted through the wire holes 221 and 222 and then turned upwardly through the wire notches 231 and 232.

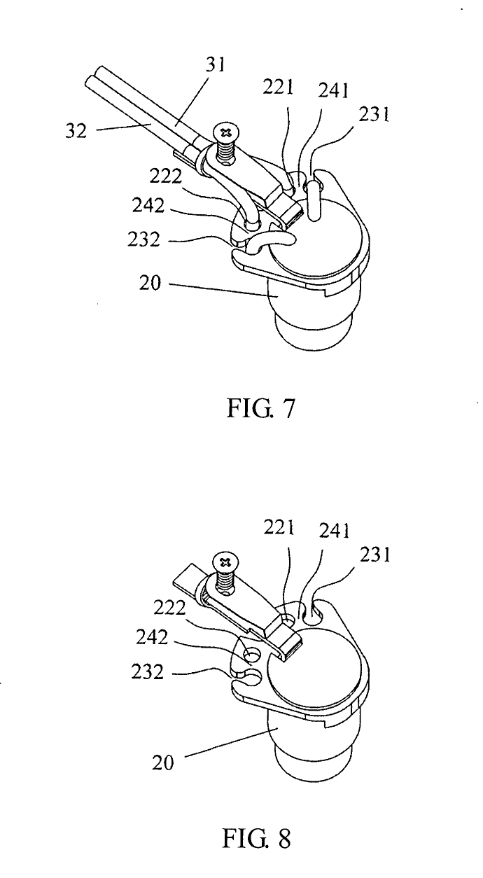

FIGS. 7 and 8 show a lamp holder in accordance with a fourth embodiment of the present invention. This fourth embodiment is substantially similar to the aforesaid third embodiment with the exception that this fourth embodiment has the two wire notches 231 and 232 respectively disposed at an outer side relative to the two wire holes 221 and 222. During installation, the two electric wires 31 and 32 are respectively inserted through the wire holes 221 and 222 and then turned moved apart and reversed and then respectively inserted through the wire notches 231 and 232.

By means of forming wire hole(s) and wire notch(es) on the integrated bracket 20 for securing electric wires instead of the conventional design of using a metal holding down plate with screws to affix electric wires, the invention simplifies the structure of the lamp holder, facilitating lamp holder fabrication, installation and delivery and saving much the cost.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A lamp holder, comprising a holder base adapted for holding a lamp bulb, an electrically insulative bracket fastened to one side of said holder base and two electric wires extended from said holder base and supported on said electrically insulative bracket for connection to an external power source, wherein said bracket comprises at least one extension lug, at least one wire notch located on the periphery of said at least one extension lug for the passing of said two electric wires, at least one wire hole cut through top and bottom sides of said at least one extension lug for the passing of said two electric wires, and two bearing portions defined between said at least one wire notch and said at least one wire hole for supporting said two electric wires respectively.

2. The lamp holder as claimed in claim 1, wherein each said wire notch has a relatively narrower front open side and a relatively larger inner close side.

3. The lamp holder as claimed in claim 1, wherein each said extension lug extends transversely from the periphery of said electrically insulative bracket.

4. The lamp holder as claimed in claim 1, wherein the number of said at least one wire hole is 1; the number of said at least one wire notch is 2; the two wire notches are respectively disposed at two opposite lateral sides relative to the wire hole; the wire hole is an oblong through hole.

5. The lamp holder as claimed in claim 1, wherein the number of said at least one wire notch is 1; the number of said at least one wire hole is 2; the two wire holes are respectively disposed at two opposite lateral sides relative to the wire notch; the wire notch is an oblong opening.

6. The lamp holder as claimed in claim 1, wherein the number of said at least one wire hole is 2; the number of said at least one wire notch is 2; the two wire notches are spaced between the two wire holes; the two wire holes are adapted for the passing of the two electric wires individually; the two wire notches are adapted for the passing of the two electric wires individually.

7. The lamp holder as claimed in claim 1, wherein the number of said at least one wire notch is 2; the number of said at least one wire hole is 2; the two wire holes are respectively disposed between the two wire notches; the two wire holes are adapted for the passing of the two electric wires individually; the two wire notches are adapted for the passing of the two electric wires individually.
